(19) United States
(12) Patent Application Publication
(10) Pub. No.: US 2012/0166652 A1
(43) Pub. Date: Jun. 28, 2012

(54) ADVANCED SIMULTANEOUS AND SEQUENTIAL SIP FORKING

(76) Inventor: Jean-Luc R. Bouthemy, Sammamish, WA (US)

(21) Appl. No.: 12/977,966

(22) Filed: Dec. 23, 2010

(51) Int. Cl. G06F 15/16

(52) U.S. Cl. 709/227

(57) ABSTRACT

Systems and methods for simultaneous and sequential routing are described. In one aspect, at least one computing device in an Internet Protocol Multimedia Subsystem (IMS) network implements a method for improving simultaneous and sequential Session Initiation Protocol (SIP) forking. More specifically, the message is received from a first device associated with a first user to establish a session with a second device of multiple devices associated with a second user. Responsive to receiving the message, and independent of whether the multiple devices are registered to a same SIP registrar (Serving Call Session Control Function) in the IMS network, a simultaneous or parallel SIP session is established to ring respective ones of the multiple devices.

### BACKGROUND

The Internet Protocol (IP) Multimedia Subsystem is a standardized set of specifications that describe a Next Generation Network (NGN) with a generic architecture for Internet Protocol (IP)-based telephony and multimedia services. Third Generation Partnership Project (3GPP) and Third Generation Partnership Project 2 (3GPP2) enable and support the evolution of mobile networks beyond second-generation (2G) mobile systems such as Global System for Mobile Communications (GSM) and cdma2000. IP Multimedia Subsystem (IMS) uses Session Initiation Protocol (SIP) to control multimedia communication sessions.

The IMS uses Public User Identities (IMPUs) to identify users and route SIP signaling. 3GPP Release 6 onwards, IMS allows users to register the same IMPU from a number of IMS devices. Registrations are differentiated based on the private identity (IMPI) and public identity (IMPU). In IMS, an IMPU is a SIP Uniform Resource Identifier (URI), Tel Uniform Resource Identifier (URI), or Globally Routable User Agent URI (GRUU). All can be used to reach resources when using SIP. A SIP URI identifies a communication resource: it is used to initiate and maintain a SIP session with the resource (e.g. an user, a device, or a service). Its format is similar to an email address (i.e. sip:user@domain although other extensions may be used. User part may be a phone number. The full syntax of SIP URI is defined as sip:user@host:port;uri-parameters?headers where user is the identifier of a particular resource, host a Fully-Qualified Domain Name, followed by optional parameters).

A tel URI contain phone numbers either local numbers (i.e. telephony numbers which are unique only within a certain geographical area or a certain part of the telephone network) or global numbers (i.e. phone numbers which are unambiguous worldwide; they include the leader character “+” followed by the country code and the national numbers). Examples of tel URI include tel:+1-201-555-0123 (a global number assigned in the United States), tel:7042;phone-context=example.com: (a local phone number valid with the “context example.com”). The Globally Routable User Agent URI (GRUU) is a URI that reaches a particular UA instance (an IMS device), but is reachable by any host on the Internet. A GRUU can be either temporary (when created in each IMS registration request to keep user's public identity hidden) or public (when it is a unique combination of a Public User Identity and an instance of the IMS device). Examples of GRUUs include pub-gruu uri=“sip:user@example.com;gr=hha9s8d-999a” (a public GRUU) and temp-gruu uri=“sip: 8ffkas08af7fasklzi9@example.com;gr” first-cseq=“54301”.

Some of the benefits of IMS core networks include, for example, support for simultaneous calling, call hunt, VoIP, and multimedia services based on standardized interfaces and reusable components, etc. Simultaneous calling is described in 3GPP specifications (e.g., 3GPP TS 23.228, 3GPP TS 24.228, and 3GPP TS 24.229) when all called parties share the same IMPU that has been registered on a same SIP server (registrar server i.e. a SIP server that accepts and processes SIP REGISTER requests. The SIP registrar provides a location service which registers IP addresses to SIP URIs) in a same network. That is, standard systems support simultaneous calling only when all subscriber devices share a same identity (i.e., the called party IMPU) and all IMPUs are registered to the same Serving Call Session Control Function (S-CSCF) in the same IMS network. This feature is also called parallel SIP forking. Forking is the ability to split or “fork” an incoming call so that several SIP clients (telephony devices) sharing the same IMPU can ring at once. The first location to answer takes the call.

FIG. 1 shows a system for simultaneous calling to the same public identity. Referring to FIG. 1, User A is calling User B. User B has multiple devices (in this diagram, all the devices are IMS capable devices. They may be phones, PDAs, laptops or other consumer devices) sharing the same public identity (IMPU). If these devices are registered in the IMS domain, all of these devices are registered to the same SIP server (registrar server i.e. Serving Call Session Control Function,). All of User B's devices (both phones) are ringing when User A is calling User B. User B can pick up any of the devices to establish a call (SIP session). The call can be audio or audio/video. Here: (a) all of the devices shall be registered with the same IMPU; (b) all of the devices shall be registered to the same registrar server (these cannot be registered in different networks); and (c) User B has no control over which devices can ring (all devices ring).

Call hunt, also called sequential forking, is a service wherein devices that share a same IMPU are called one by one. That is, if the call is not answered on a first device within a time limit, ringing is terminated on the first device and the call is transferred to a second device (the second device rings). If the timer (time limit) expires, the second device stops ringing and a third device rings, and so on, until the call is forwarded to a last device if not previously answered.

### BRIEF DESCRIPTION OF THE DRAWINGS

In the Figures, the left-most digit of a component reference number identifies the particular Figure in which the component first appears.

FIG. 1 shows a system for parallel call forking.

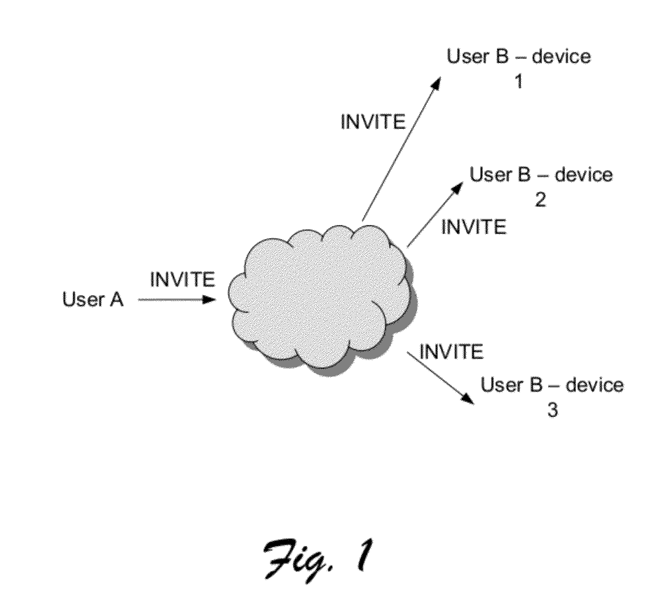

FIG. 2 shows an exemplary system for simultaneous and sequential SIP session (SIP forking), according to one embodiment. More particularly, FIG. 2 shows an exemplary system for simultaneous SIP session and sequential SIP session establishment to any public identities for an IMS originated call.

FIG. 3 shows an exemplary system for simultaneous and sequential SIP forking to any public identities for an IMS terminated session, according to one embodiment.

FIG. 4 shows an exemplary procedure for simultaneous SIP and sequential SIP forking to any user-specified public identities, according to one embodiment.

### DETAILED DESCRIPTION

Overview

The systems and methods for simultaneous and sequential SIP forking described herein provide simultaneous and sequential forking support to multiple IMS subscribers by establishing multiple SIP session dialogs from a single SIP request in the IMS domain. In contrast to conventional parallel and sequential SIP forking (collectively “SIP forking”) techniques that require all subscriber devices to share a same IMPU to participate, for example, in simultaneous and sequential SIP session establishment, the systems and methods described herein provide SIP forking to any public identities, including parties that do not share a same IMPU (regardless of where they are registered and as assigned to resources) without contribution from the recipients or the originator. That is, parties participating in a SIP forking event may have different IMPUs. In one embodiment, one or more of the IMPUs are regular phone numbers. Additionally, the described systems and methods allow multiple parties (with a same IMPU or with different IMPUs) to be registered on different S-CSCFs. In one implementation, the systems and methods for simultaneous and sequential SIP session establishment allow registration of parties with different telephony operators (networks) including PSTN or circuit-switched networks.

To these ends, the systems and methods for simultaneous and sequential call routing include an application server to implement SIP forking based on a call profile. A user can define his/her user profile: for example, which IMPUs are used for simultaneous or sequential SIP session when someone initiates a SIP session. The user may include other criteria such as time of day or calling party number(s). Users define on which devices they want to answer as part of the user profile. Some of the devices may even be registered on other networks. A user profile may be rule-based (e.g., based on time of day). Using the systems and methods, a user can update their user profile at any time. In one implementation, the user profile is stored in a call profile store. In another implementation, the user profile is stored in a database such as the Home Subscriber Server (HSS) or in an XML Document Management Server (XDMS).

These and other aspects of the systems and methods for simultaneous and sequential SIP session establishment are now described in greater detail.

An Exemplary System

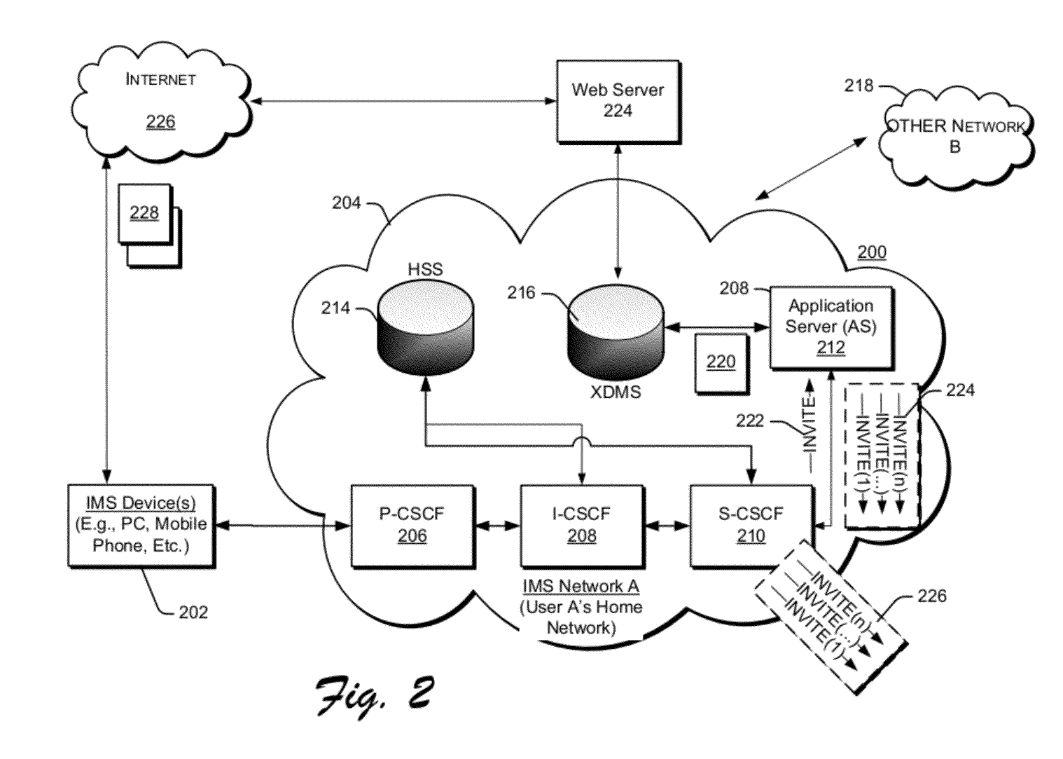

FIG. 2 shows an exemplary environment 200 capable of implementing simultaneous and sequential SIP forking according to one embodiment. Environment 200 includes IMS device(s) 202 operatively coupled to network 204 IMS device(s) 202 is/are, for example, SIP-enabled device(s) such as mobile handsets/phones, Personal Digital Assistants (PDAs), personal computers, etc. Network 204 is an IMS network that includes, for example, Proxy Call Session Control Function (P-CSCF) 206, Interrogating Call Session Control Function (I-CSCF) 208, Serving Call Session Control Function (S-CSCF) 210, Application Server (AS) 212, Home Subscriber Server (HSS) 214, and XML Database Management Server 216. P-CSCF 206 is a first point of contact in the IMS network for IMS devices 202. All SIP signaling traffic to/from the IMS devices must go through the P-CSCF. It validates and then forwards requests from IMS devices and that the P-CSCF processes and forwards the responses to IMS devices. The P-CSCF can also function as a user agent (UA) in the context of the SIP operating procedures. For example, if an abnormal condition arises in a session, the P-CSCF can unilaterally release the session for the IMS capable device (e.g. 3G handset also call User Equipment). The UA role can also come in handy to generate independent SIP messages required during the registration such as sending the user's public and private identities. The P-CSCF ensures secure communications by establishing and maintaining IPSec or TLS security associations, and applying integrity and confidentiality for SIP signaling, compression/decompression (SIP compression), interaction with services, and emergency session detection.

The Interrogating-Call Session Control Function (I-CSCF) is the point of contact for IMS users in their home network. The I-CSCF 208 facilitates all connections for that IMS user. Among other operations, the I-CSCF 208 provides the name of the next hop (either an application server such as application server 212 or S-CSCF 210), and routes incoming requests to an assigned S-CSCF or application server depending on the information retrieved from the HSS 214. HSS 214 is a user database that provides information pertaining, for example, to subscriber profiles, authentication and authorization of user(s), and may provide information about a subscriber's location and IP information.

S-CSCF 210 is a SIP server that handles SIP registrations, performs session control, and provides routing services to forward SIP messages to appropriate application server(s) such as application server 212 or other nodes (e.g., to continue a session in the IMS domain or to a Breakout Gateway Control Function or BGCF (not shown) to breakout in a circuit-switched domain). S-CSCF also interfaces with the HSS 214 to download user profiles.

Other components in IMS network 204 may include, for example, one or more known components that are not shown in FIG. 2 such as an Electronic Number Mapping (ENUM) database, media server(s), media gateway(s), a Breakout Control Gateway Function (BCGF), PSTN/CS gateway interface(s) with PSTN circuit switched (CS) network(s), and/or so on.

Network 204 can also be a SIP network composed of one or several SIP servers. The SIP server receiving SIP requests such as INVITE shall query the user profile before processing SIP requests.

IMS Device Registration

IMS devices register to their respective S-CSCF assigned in their home network. IMS devices register with their home IMS network using known techniques such as those as defined by 3GPP TS 23.228, 3GPP TS 24.228, and 3GPP TS 24.229. In this particular implementation, IMS network 204 is the home network for one or more of IMS device(s) 202. In another implementation, the home network for one or more other ones of IMS devices 202, for example, may be IMS network 218. IMS devices 202 can register directly on an IMS network (e.g., networks 204) using Internet Protocol (IP) and SIP user agents. Network 218 can be an IMS network, an IP network (e.g. supporting SIP) or Circuit-Switched network (in that gateways such as MGCF and BGCF are required to translate protocols between IMS and circuit-switched networks as defined by 3GPP—not described in this submission), or an IP network. In one implementation, fixed access (e.g., Digital Subscriber Line (DSL), cable modems, Ethernet), mobile access (e.g., W-CDMA, CDMA2000, GSM, and GPRS), and wireless access (e.g., WLAN, WiMAX) are all supported. Other phone systems like plain old telephone service (POTS—the old analog telephones), H.323, and non IMS-compatible VoIP systems, are supported through gateways.

### User Simultaneous and Sequential SIP session “User Profile” Definition

A user of an IMS device 202 defines a user profile 220 to indicate, for example, which IMPUs are to be used for simultaneous and/or sequential SIP forking by IMS network 204 when someone initiates a SIP session to the user. To define/create the user profile 220, a user indicates the particular IMS devices 202 to answer responsive to simultaneous or sequential SIP forking as part of the user profile. In one implementation, one or more of the IMS devices identified in the user profile 220 for SIP forking services is/are registered to a communication network different from the home network 204. For example, one or more of the IMS devices 202 specified in user profile 220 may be registered in network 218 or another network. The user profile 210 may be rule-based (e.g., based on time of day, and/or based on other criteria). In one implementation, user profile 220 is stored on XDMS 216. In another addition, user profile 220 is stored on a different database (e.g., HSS 214, and/or so on).

TABLE 1 shows an exemplary user profile 220 defined in Extensible Markup Language (XML).

TABLE 1
Exemplary User Profile

<user profile>

<ringing>
<type>simultaneous or parallel SIP session <type>
<criteria>

<day>day</day>
<start time>time</start time>
<end time>time</end time>

</criteria>

<impu>IMPU1</impu>

<impu>IMPU2</impu>

</ ringing>
</user profile>
Notes:
The IMPU could be a SIP URI, a Tel URI or GRUU.
Similar profile to forward messaging to multiple devices/end-users

Referring to TABLE 1, exemplary user profile 220 specifies characteristics for ringing (simultaneous or sequential SIP session), as illustrated by the data between tags “<ringing>” and “</ringing>.” More particularly, the information between tags “<type>” and “</type>” particularly specifies the type of ringing to be performed (simultaneous or sequential SIP session type ringing). Information between tags “<criteria>” and “</criteria>” indicate any rules-based criteria to be evaluated for conditions associated with SIP sessions. In this particular example, such criteria include the particular day(s) and time(s) of day (i.e., start and end times for each day). These illustrated criteria are examples only and this and/or other criterion and criteria may be specified. The information between tags “<impu>” and “</impu>” indicate each respective IMPU(s) that is/are to participate in establishing SIP session of the described systems and methods. The illustrated tags are examples only, and other tags and information within the described SIP session contexts may be specified in a user's call profile 220.

In one implementation, a user interacts with a user interface served by application server 212 to define user profile 220 for storage by the application server in a database. In another implementation, the user interfaces with a third-party Web server 224 via the Internet 226 to generate the user profile 220 from a series of served web pages 228. That profile can be stored into e.g. the XDMS 216. In this scenario, the IMS device 202 is used to upload the user profile to application server 212 for storage and subsequent access in the IMS network.

### SIP Forking to Any Public Identities—IMS Originated SIP Sessions

The systems and methods of environment 200 for simultaneous and sequential SIP forking provide simultaneous and/or sequential SIP sessions established for any public entities for IMS-originated calls and IMS-terminated calls. In a scenario of an IMS-originated call, an IMS device 202 associated with User A communicates a SIP INVITE (requesting a session with User B) to S-CSCF 210 (the originated S-CSCF). Responsive to receiving the SIP INVITE message, and based on the corresponding user's (“User A”) initial Filter Criteria (iFC), the SIP INVITE (INVITE 222) is routed to the application server 212. The iFC is a collection of conditions for service invocation with application server(s) responsible for execution of the associated service logic. In this implementation, the iFCs, as subsets of the User Profile, are already downloaded from the HSS 214 during assignment procedure and are stored locally at the S-CSCF 210.

Responsive to receiving the SIP INVITE 222 from S-CSCF 210, application server 212 fetches user profile 220 from XDMS 216 (or another database) for User B (the B party). Based on the user profile 220, application server 212 either forwards INVITE 222 to S-CSCF 210 or establishes several legs (SIP forking) as illustrated in INVITE block 224. Application server 212 remains in the signaling path so that if the SIP session is answered on one of the devices 202, the SIP sessions is terminated for the other legs. Application server 212 sends these INVITE messages to S-CSCF 210 over the IMS Session Control (ISC) reference point between S-CSCF 210 and application server 212. As shown in message block 226, S-CSCF 210 routes respective ones of the received INVITE messages 224.

### IMS Terminated SIP Sessions

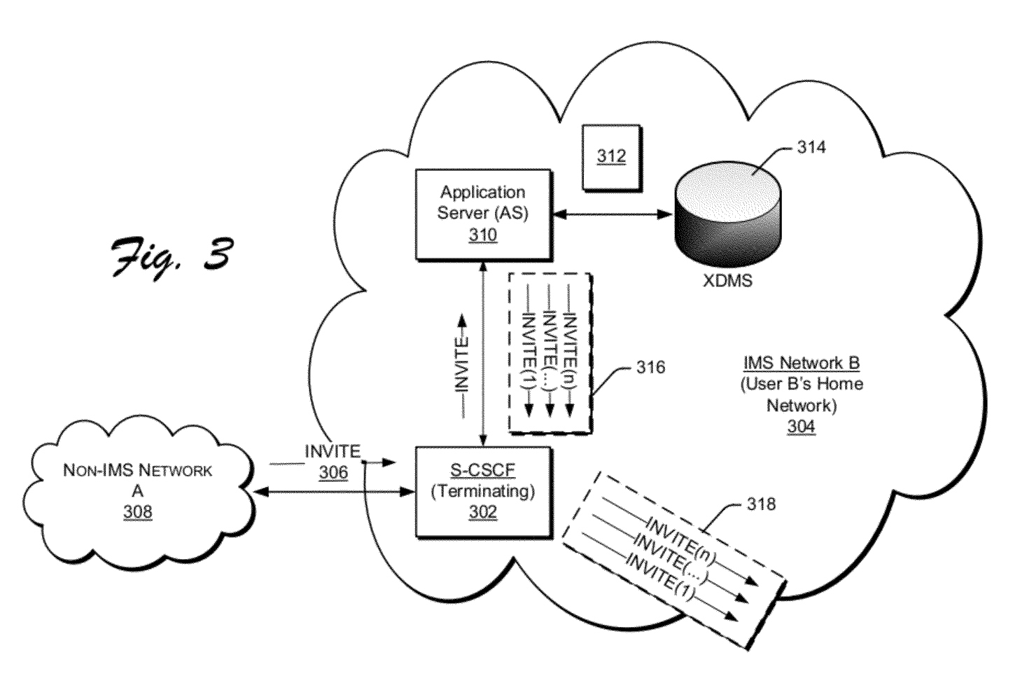

FIG. 3 shows an exemplary environment for SIP forking in the context of IMS terminated calls, according to one embodiment. As shown, a terminated S-CSCF 302 in IMS network B (304) receives a SIP INVITE message 306 for User B from another network/non-IMS domain 308. The terminated S-CSCF, based on User B's iFC, forwards the INVITE message to Application Server 310. Responsive to receiving the INVITE message, Application Server 310 fetches user profile 312 from a database 314 such as an XDMS or other database. Based on the retrieved user profile 312, application server 310 either forwards the INVITE message to S-CSCF 302 or establishes several legs for the SIP sessions, as illustrated in INVITE message block 316. These INVITE messages 316 are sent to S-CSCF 302 over the ISC reference point. S-CSCF 302 routes the received INVITE messages as illustrated in block 318. In this scenario, application server 310 remains in the signaling path so that if the call is answered on one of the target devices, Application Server 310 will terminate the SIP session on the other legs of the simultaneous or sequential SIP forking.

An Exemplary Procedure

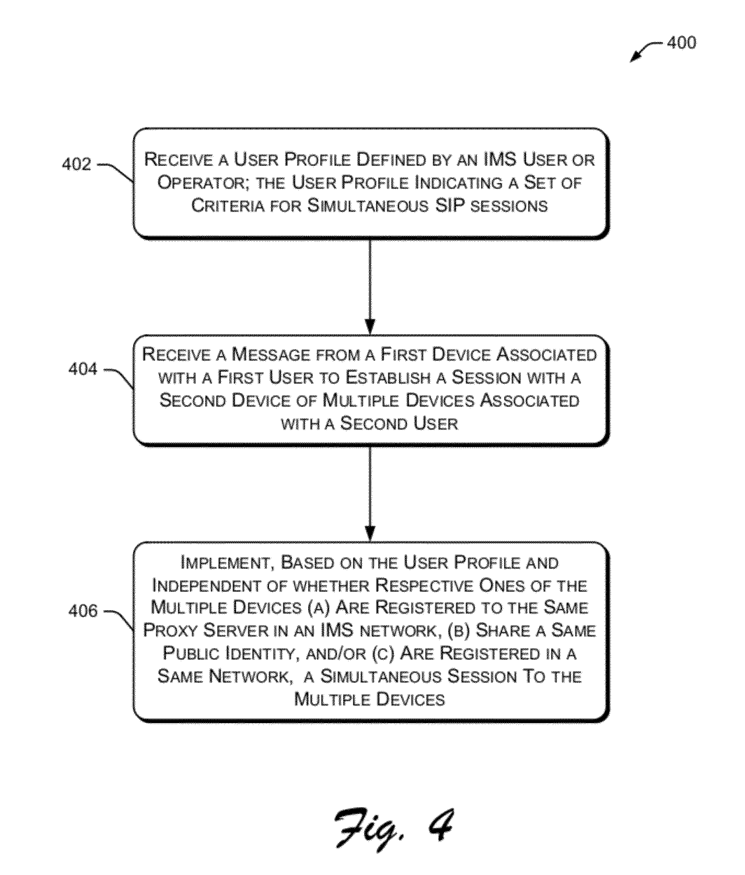

FIG. 4 shows an exemplary procedure 400 for SIP forking in a communication network that includes at least one IMS network, according to one embodiment. At block 402, the procedure receives a user profile defined by an IMS user or an IMS operator. The user profile indicates a set of criteria for SIP forking as defined herein. An exemplary user profile is described above with respect to user profile 220 of FIG. 2 (see also the exemplary format of TABLE 1). In one implementation, the criteria specified in a user profile indicates which public identities (IMPUs) associated with respective ones of the multiple IMS devices (SIP-enabled devices) shall be used for simultaneous or sequential SIP forking when another party (an IMS subscriber) requests a SIP session with the second user (another IMS subscriber). In one implementation, the set of criteria in a user profile directs an application server (e.g., application server 212 of FIG. 2) in the IMS network whether to call a respective device of multiple devices associated with a target user during the SIP session. An exemplary such user profile is also shown in TABLE 1, above.

Operations of block 404 receive a message (e.g., a SIP INVITE) to establish a SIP session between first and second IMS subscribers. Operations of block 406, responsive to receiving the message to establish the SIP session implement, based on characteristics specified in the user profile, call routing to respective ones of multiple devices associated with the target second IMS subscriber. Significantly, the operations of block 406 to implement SIP forking (simultaneous or sequential SIP establishment) are completely independent of whether or not respective ones of multiple SIP-enabled devices associated with the target IMS subscriber share a same public identity. Additionally, these operations are completely independent of whether or not the public identities are registered with a same SIP proxy server. Moreover, these operations are completely independent of whether or not the devices in corresponding public identities are registered in a same communication network.

In view of the above, the systems and methods described herein in reference to FIGS. 2 through 4 for SIP forking are in stark contrast to conventional systems and techniques to implement SIP forking. In such standard/conventional call forking implementations, call forking is established only when: (1) all of the devices registered to a target IMS party have a same/shared public identity (IMPU); and (2) all of the devices are registered with a same SIP proxy server (these cannot be registered in different networks). Moreover, in conventional call forking implementations, a user of an IMS device has no control over which devices associated with the user will ring (be called) in a call forking scenario—e.g., all functioning devices will ring in simultaneous or sequential calling.

### CONCLUSION

Although the systems and methods for call forking have been described in language specific to structural features and/or methodological operations or actions, it is understood that the implementations defined in the appended claims are not necessarily limited to the specific features or actions described. Rather, the specific features and operations of routing data are disclosed as exemplary forms of implementing the claimed subject matter.

1. A method implemented by at least one computing Session Initiation Protocol (SIP) device in a IP Multimedia Subsystem (IMS) network, the method comprising:
receiving a message from a first device associated with a first user to establish a session with a second device of multiple devices associated with a second user; and
responsive to receiving the message, implementing, independent of whether the multiple devices are registered to a same Serving Call Session Control Function (S-CSCF) in the IMS network, simultaneous or sequential SIP forking to the multiple devices.

2. The method of claim 1 wherein the IMS network is a first IMS network, and wherein at least one device of the multiple devices is registered with a different S-CSCF in a second IMS network independent of the first IMS network.

3. The method of claim 1 wherein the second device is registered with a first public identity that is different from a second public identity of a different device of the multiple devices.

4. The method of claim 3 wherein the second device is registered to a first CSCF and wherein the different device is registered to a second proxy server, the first CSCF being separate from the second CSCF.

5. The method of claim 1 wherein implementing the SIP forking (e.g. for calls and/or messaging) to the multiple devices further comprises establishing respective call sessions with particular ones of the multiple devices according to a set of criteria defined by the second user.

6. The method of claim 5 wherein the method further comprises receiving a user profile defined by the second user indicating the set of criteria.

7. The method of claim 6 wherein the set of criteria indicates which public identities associated with respective ones of the multiple devices is for simultaneous or sequential SIP forking (SIP establishment) when another party requests a call session with the second user.

8. The method of claim 6 wherein the set of criteria directs an IMS application server in the IMS network whether to call a respective device of the multiple devices during the SIP session establishment (SIP forking).

9. The method of claim 1 wherein the message is a SIP INVITE, and wherein:
receiving the message further comprises communicating the message by a Serving Call Session Control Function (S-CSCF), based on initial filter criteria to an application server; and
wherein the method further comprises:
responsive to receiving the message, evaluating, by the application server, a user profile pertaining to the second user to: (a) determine respective ones of the multiple devices based on one or more public identities (IMPUs) identified in the user profile; (b) a set of rules-based criteria for evaluation prior to establishing a session with one or more of the multiple devices; and (c) determine whether to forward the message to the S-CSCF for processing, or establish multiple SIP INVITE messages to the S-SCSF for call forking to respective ones of the multiple devices.

10. A method for call forking in one or more communication networks including an Internet Protocol Multimedia Subsystem (IMS) network, the method comprising:
receiving a message from a first device associated with a first user to establish a session with a second device of multiple devices associated with a second user; and
responsive to receiving the message, implementing a simultaneous or a parallel SIP forking via Session Initiation Protocol (SIP) to the multiple devices, the SIP forking being implemented: (a) independent of whether the multiple devices are registered to a same S-CSCF in the IMS network; (b) independent of whether each device of the multiple devices is associated with a same public identity (IMPU); and (c) independent of whether one or more of the multiple devices is registered in a different network as compared to the network registration of another device of the multiple devices.

11. The method of claim 10 wherein the IMS network is a first IMS network, and wherein at least one device of the multiple devices is registered with a different S-CSCF in a second IMS network independent of the first IMS network.

12. The method of claim 10 wherein the second device is registered with a first public identity that is different from a second public identity of a different device of the multiple devices.

13. The system of claim 10 wherein implementing the SIP forking to the multiple devices further comprises establishing respective SIP sessions with particular ones of the multiple devices according to a set of criteria defined by the second user.

14. A system in an Internet Protocol Multimedia Subsystem (IMS) network, the system comprising one or more components to implement simultaneous and sequential SIP forking, the one or more components comprising respective processor(s) operatively configured to execute computer program instructions from tangible computer readable memory, the computer program instructions for performing operations comprising:
receiving a message from a first device associated with a first user to establish a session with a second device of multiple devices associated with a second user; and
responsive to receiving the message, implementing a forked session via SIP forking to the multiple devices, the forked call being implemented: (a) independent of whether the multiple devices are registered to a same proxy server in the IMS network; (b) independent of whether each device of the multiple devices is associated with a same public identity (IMPU); and (c) independent of whether one or more of the multiple devices is registered in a different network as compared to the network registration of another device of the multiple devices.

15. The system of claim 14 wherein the IMS network is a first IMS network, and wherein at least one device of the multiple devices is registered with a different proxy server in a second IMS network independent of the first IMS network.

16. The system of claim 14 wherein the second device is registered with a first public identity that is different from a second public identity of a different device of the multiple devices.

17. The system of claim 14 wherein the components comprise a Serving Call Session Control Function (S-CSCF) in an application server, and wherein the message is a SIP INVITE, and wherein:
receiving the message further comprises communicating the message by the S-CSCF, based on initial filter criteria to the application server; and
wherein the method further comprises:
responsive to receiving the message, evaluating, by the application server, a user profile pertaining to the second user to:
(a) determine respective ones of the multiple devices based on one or more public identities (IMPUs) identified in the user profile;
(b) a set of rules-based criteria for evaluation prior to establishing a session with one or more of the multiple devices; and
(c) determine whether to forward the message to the S-CSCF for processing, or establish multiple SIP INVITE messages to the S-SCSF for simultaneous or sequential SIP forking to respective ones of the multiple devices.

18. The system of claim 14 wherein implementing the forked session to the multiple devices further comprises establishing respective SIP sessions with particular ones of the multiple devices according to a set of criteria defined by the second user.

19. The method of claim 18 wherein the set of criteria indicates which public identities associated with respective ones of the multiple devices will be used for SIP forking (simultaneous or sequential session establishment) when another party requests a SIP session with the second user.

20. The method of claim 18 wherein the set of criteria directs an application server in the IMS network whether to call a respective device of the multiple devices during the forked session.

21. A method implemented by at least one computing Session Initiation Protocol (SIP) device in an SIP network, the method comprising:
receiving a message from a first device associated with a first user to establish a session with a second device of multiple devices associated with a second user; and
responsive to receiving the message, implementing, independent of whether the multiple devices are registered to a same SIP server in the SIP network, simultaneous or sequential forking to the multiple devices.
